(19) United States
(12) Patent Application Publication
(10) Pub. No.: US 2012/0028535 A1
(43) Pub. Date: Feb. 2, 2012

(54) One Sensor Direction Finder

(76) Inventor: Michael Sivan, Shatin-Fotan (HK)

(21) Appl. No.: 12/843,889

(22) Filed: Jul. 27, 2010

(51) Int. Cl. A63H 33/00; G01B 11/26

(52) U.S. Cl. 446/175; 250/214 R

(57) ABSTRACT

A low cost method making use of a single sensor only, to detect the relative direction of a light source. Most suitable for toys and low cost gadgets.

### FIELD OF THE INVENTION

The present invention relates to any toy or gadget which needs a low cost means to identify the relative direction of a light source.

### BACKGROUND OF THE INVENTION

The ability to identify, at very low cost, the relative direction of incoming light, whether it is a light source, or a reflected or a diffused light spot allows a new range of applications for electronic toys and low cost electronic gadgets. Examples—(1) a plush toy pet who turns his head and ‘looks’ towards a moving light; (2) a car or helicopter that follows a light spot on the floor or on wall.

Furthermore, low cost ability to identify the direction of incoming light provides for a new and very low cost method to make a low cost radar to identify obstacles, walls and other nearby objects. Example, by illuminating evenly the hemisphere in front of a toy car, the nearest wall will diffuse back towards the car the strongest light. Thereafter, by making use of the present invention, the car will identify the direction of that stronger light (i.e. the wall) and change direction of movement so as not to bump into the wall.

U.S. Pat. No. 7,147,535 describes a method for identifying the direction of a light spot on the ground making use of no less than two sensors. PCT International Patent Application PCT/FR08/00006 describes an automatic helicopter incorporating a radar which also makes use of no less that two sensors.

In both patents, as well as in all prior art, at least two sensors are required to find the direction of light in one axis (e.g. light coming from right or left). If there is a need to know the direction also on another axis (e.g. up or down), then a third and forth sensors are required. If the direction of the light source needs to be determined more accurately, then more sensors will be required. The count of sensors can continue to rise for additional resolution up to millions (e.g. CCD or CMOS sensing devices mostly used in digital cameras, which basically comprise of a very large two dimensional matrix of millions of small sensors). Obviously there is a price to pay for a higher count of sensors which is a practical limitation in designing low cost toys.

All the above-mentioned prior art is making use of Directional Sensors. A Directional Sensor is one that is more sensitive to light signal coming from its main axis—light coming from the sensor's ‘front’ or light coming from the direction at which the sensor is ‘looking’. ‘More sensitive’ means that (a) for the same light intensity—the sensor will create a stronger electronic signal at the sensor's output pins connected to the electronic circuitry. Alternatively, ‘more sensitive’ can mean that (b) a lower light intensity will cause the sensor to react electronically. The most popular and low cost Infra-Red sensors in the market (e.g. used with remote controls for toys, and used for commercial TVs)—are of (b) type.

By positioning at least two sensors at different angles, the incoming light beam will effect differently the two sensors. That sensor which is ‘looking’ (or almost looking) at the light source will be more sensitive (as described above). With proper electronic signal processing, and thereafter comparison between the processed signals of both sensors—the direction of the incoming light relative to the position of the sensors is determined.

The present invention describes new and different methods of differentiating between directions of incoming light and by using only one single sensor. This invention provides for significant cost savings and as such provides for new toy and gadget applications.

### SUMMARY OF THE PRESENT INVENTION

This invention provides for differentiation of the direction of incoming light to one single sensor by using one or more of the following directional differentiations:
1) Directional differentiation by electronic shutters
2) Directional differentiation by mechanical means
3) Directional differentiation by Synchronized Timing

### THE PRESENT INVENTION IN DETAIL

1) Directional Differentiation by Electronic Shutters

This method describes a method to differentiate the relative direction of an incoming beam. The single sensor is ‘looking’ towards the half hemisphere in front of it, while in front of the sensor there is a matrix of shutters that block the light beam. Only one shutter does not block the light and in such case only a light beam that comes in the exact direction to go through that open shutter to hit the sensor—will effect the sensor. By switching one at the time each shutter—the direction of the light may be determined.

The following describes a preferred embodiment which will also more clarify the method:

A single light sensor 11 (FIG. 1) is situated in front of a square LCD display 12. Both sit on PCBs 13 which includes a microcontroller (MCU) 14 connected to the sensor and to the LCD (through an LCD driver). The LCD 12 has 9 equal squares of graphic segments, each square can be driven to be opaque (ON) or transparent (OFF) by applying proper control voltage on its 3 segments and 3 commons which are connected directly to the MCU (or through the LCD driver).

The ON or OFF of each square is controlled by the MCU. There are 9 different states. In each state the MCU switches OFF one square while keeping all other 8 squares in ON state. After a short time, the MCU switches to the next state in which the previous OFF square switches to ON, and the next in turn square switches to OFF. Refer to the sequence of states depicted in FIG. 2.

Assuming there is a light source behind the LCD, then that light will be visible to the sensor only on that specific state (out of nine states) in which the square which is exactly in the path between the light spot and the sensor is OFF (i.e. allows light through). At that state the sensor will output a signal telling the MCU that light has been detected. The MCU, knowing well which state it is (i.e. which square is OFF) will determine accordingly the direction of the light.

For finer resolutions, the number of squares could be increased. For the minimal configuration—the matrix of 3×3 (width × height of 9 squares) is reduced to a matrix of 2×1. Such minimal configuration is sufficient for provide an embodiment of a remote control toy car to follow a light spot on the ground.

2) Directional Differentiation by Mechanical Means

In a similar way to the described above. The relative direction of incoming light can be determined by physically moving elements, which at a given point of time allow only light beam coming from one direction to hit the sensor, while blocking (or sufficiently reducing the level) of all other light beams. After a short time, by physically moving some parts mechanically, only a light beam coming from another direction will be allowed to hit the sensor. By comparing over the time the relative lights from all instants—the direction of the light can be determined.

A preferred method is described in FIG. 3. A single sensor 31 is positioned ‘looking up’. A reflecting mirror 32 is positioned above in 45 degrees angle in such a way that incoming light 33 will be reflected down towards the sensor. The mirror is connected to the shaft 35 which is connected to a motor 36 which causes the mirror to rotate in the vertical axis. Accordingly, the light source 37 will be ‘seen’ by the sensor only during that short period of time in which the mirror is facing that light source.

3) Directional Differentiation by Synchronized Timing

This method is mostly suitable for low cost radar. In a preferred embodiment, there is a microcontroller (‘MCU’) connected to the Infra-Red sensor 41, right Infra-Red LED 42, and left I/R LED 43. The MCU will alternatively switch ON and OFF each I/R LED as shown in FIG. 4.1 and FIG. 4.2. In FIG. 4.1 the obstacle 44 on the left will diffuse light 45 arriving from left LED 43, and the sensor 41 will ‘see’ the diffused light 46. However, in FIG. 4.2 the right LED 42 will emit light which will not be diffused by the obstacle and the sensor will ‘see’ nothing. Because the same MCU controls the alternating I/R LEDs 42 and 43 as well as the sensor—the MCU will know exactly, by its time synchronization, which LED was ON during the time that the sensor was receiving a signal. With this information—the MCU determines the direction of the light.

### BRIEF DESCRIPTION OF THE DRAWINGS

FIG. 1: Electronic Shutters

FIG. 2: Alternating States

FIG. 3: Rotating Mirror

FIG. 4: Synchronized Timing

FIG. 4.1: Synchronized Timing—Left LED is ON

FIG. 4.2: Synchronized Timing—Right LED is ON

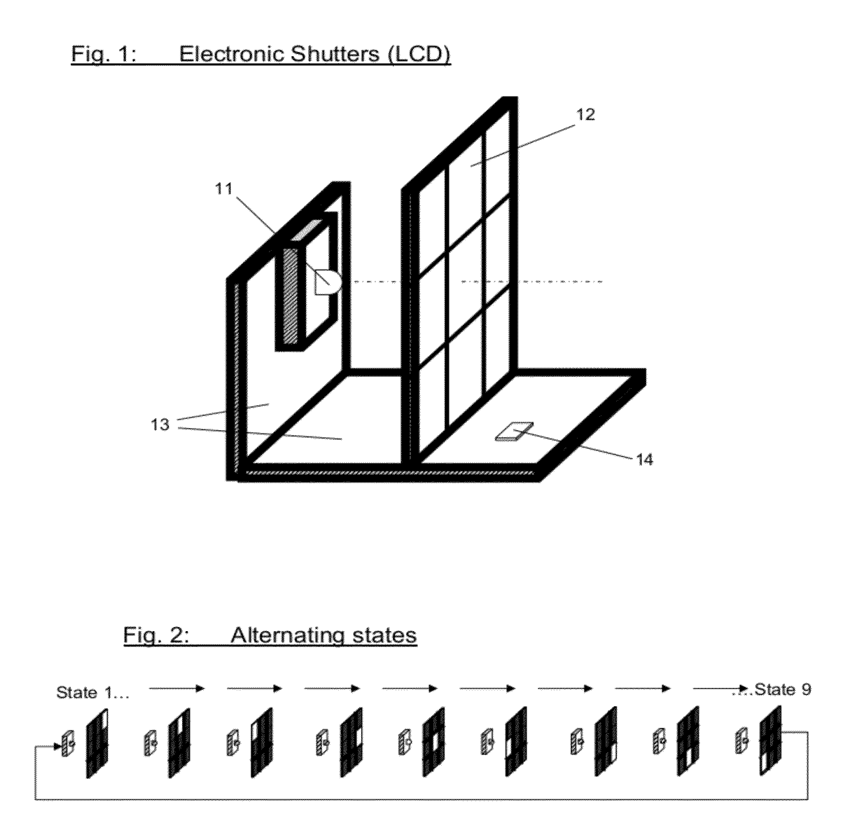

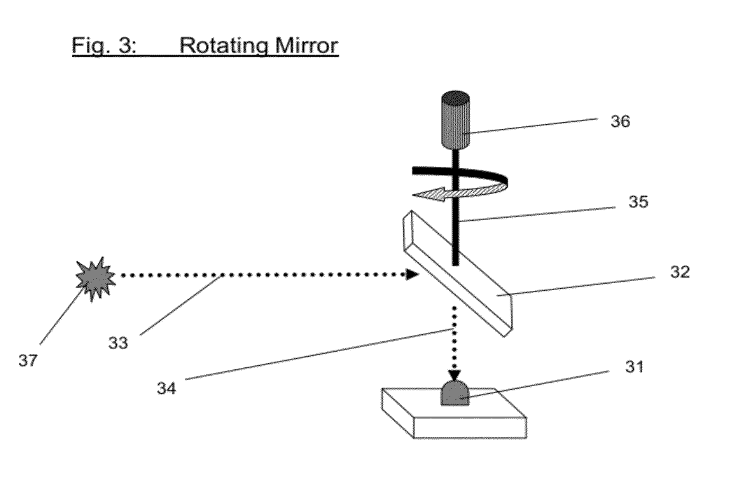

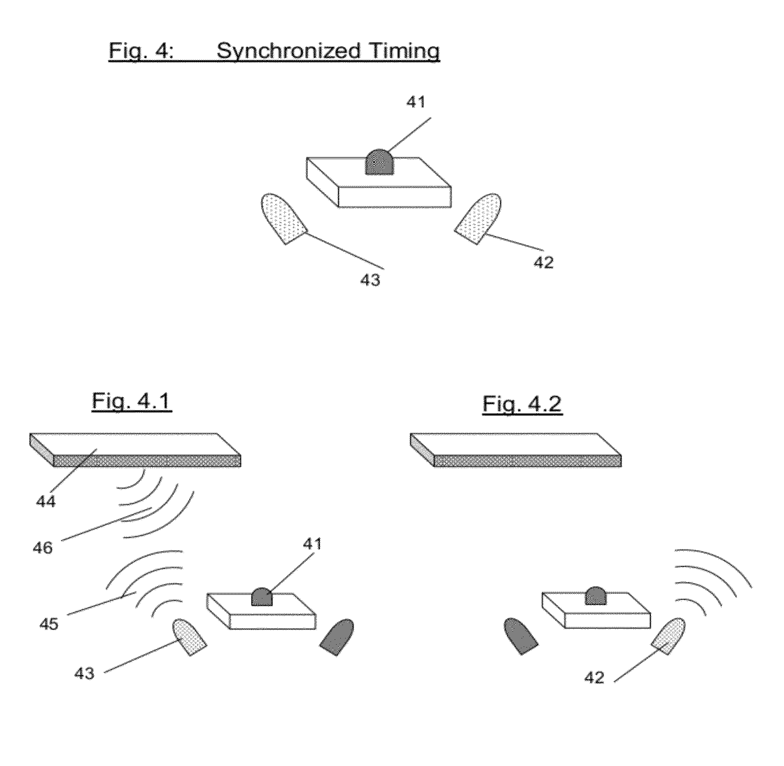

### REFERENCES CITED

US Patents

U.S. Pat. No. 7,147,535 Dec. 12, 2006 Simeray

Other References

PCT/FR08/00006 Jan. 2, 2008 Simeray

1. A toy consisting of one light sensor, a matrix of LCD light shutters and at least one microcontroller (MCU') which is connected to both light sensor and matrix The matrix consists of either one LCD piece with at least 2 light shutters, or more than 2 LCD pieces each having at least one light shutter. The MCU controls the timing in which each of the light shutters is ON or OFF. At same time the MCU analyses the signals as received by the sensor and determines at what time the light intensity received by the sensor was at its peak. By correlating that time with the light shutter which allowed at that time the light to come through to the sensor—the MCU determines the direction of the light, and accordingly effects the behavior of the toy. ‘Light’ shall mean in all claims either visible light, or infra-red light or ultra-violet light.

2. A toy as described in claim 1, except that the matrix is made of mechanical shutters rather than LCD shutters and which are switched to ON or OFF by motors or electromagnets.

3. A toy consisting of one light sensor, an MCU and a rotating or oscillating mirror that moves by means of a motor or electromagnet. At every moment there is one preferred angle in space from which the light will be reflected by the mirror towards the sensor. Accordingly, during the movements of the mirror, that preferred angle changes until it covers all the angles of interest to that toy. At any point of time the MCU knows exactly which is the preferred angle, either by open-loop by controlling the exact movements of the mirror, or by closed-loop by having a reference light source shining on the mirror at a specific angle during the mirror's rotation/movement, which results in automatic and continuous calibration of the known position of the mirror in reference to the known fixed position of that reference light source.

4. A toy consisting of one light sensor, an MCU and at least 2 light sources aiming at different directions. The MCU controls the light sources and switches each light source ON or OFF alternatively. At same time the MCU gauges the time in which the peak light intensity is received by the light sensor. By correlating the time in which the peak light intensity is received by the sensor, with the light source which was ON at that exact time, the MCU determines the direction of the obstacle reflecting or defusing the light emitted by the toy's light sources and thereafter the toy acts upon this information.

5. A toy consisting of one light sensor and an MCU. There are at least 2 light sources located in different physical locations within a visible distance from the toy. The light sources are timed to switch ON and OFF alternately while fully being synchronized with the MCU of the toy, i.e. the MCU will know exactly at any point of time time which light source is ON or OFF. The sensor receives each light signal from each light source while the MCU analyzes the light intensity. By correlating each processed signal with its respective light source position, the MCU can determine the relative physical position of the toy.
